(19) United States
(12) Patent Application Publication
(10) Pub. No.: US 2009/0141043 A1
(43) Pub. Date: Jun. 4, 2009

(54) Image mosaicing apparatus for mitigating curling effect

(75) Inventors: Tao Guo, Kodaira (JP); Masashi Koga, Hachioji (JP)

Correspondence Address: REED SMITH LLP, 3110 FAIRVIEW PARK DRIVE, SUITE 1400, FALLS CHURCH, VA, 22042, US

(73) Assignee: Hitachi, Ltd.

(21) Appl. No.: 12/000,853

(22) Filed: Dec. 18, 2007

(30) Foreign Application Priority Data
Nov. 30, 2007 (JP) 2007-310063

(51) Int. Cl. G09G 5/00

(52) U.S. Cl. 345/629

(57) ABSTRACT

The mosaicing curling effect which causes a mosaic strip to curl is effectively mitigated in a system for generating a mosaic image from sequential images which partially overlap with one another. The system has a matrix estimating unit, an adjustment element calculating unit, and an image projecting unit. The matrix estimating unit estimates a transformation matrix for transformation between two adjacent images taken out from among the sequential images. The adjustment element calculating unit calculates an adjustment element of the estimated transformation matrix by decomposing the transformation matrix into a rotational component and a perspective component. The image projecting unit projects each image on the mosaic plane using the transformation matrix to which the calculated adjustment element has been applied.

### CLAIM OF PRIORITY

The present application claims priority from Japanese patent application JP 2007-310063 filed on Nov. 30, 2007, the content of which is hereby incorporated by reference into this application.

### BACKGROUND OF THE INVENTION

This invention relates to projecting and aligning image sequences onto a predetermined plane.

Image mosaicing (mosaic image generation) is a very common method of generating a large field of view (FOV) by aligning images onto a predetermined plane called mosaic plane. It has popular applications in producing an image map from aerial photos, and as well in creating a panorama image from pictures taken by a normal digital camera.

A mosaic image makes it possible to obtain a large FOV by aligning a plurality of images on a predetermined mosaic plane. In image mosaicing, if complete information on the spatial orientation and position of each image is provided, the images can be projected straightforwardly to be aligned on a mosaic plane. However, it requires very expensive equipment to precisely record the attitude of a platform and also a complicated sensor model to reconstruct the orientation parameters of images. Therefore such conventional method is normally costly as a whole. The common mosaicing method is very similar to panorama image generation. The common mosaicing method generally includes the steps of: registering the successive images based on the corresponding features; adding control information to adjust mosaicing errors; composing a mosaic strip on the mosaic plane; and outputting the results.

Images are transformed to a mosaic plane by using a transformation matrix (homography). There are two general approaches to estimate a transformation matrix: image orientation based on pose recovery of a sensor (e.g., camera) and image feature-based registration. For the former approach, an image can be spatially rectified using parameters available in the six parameters of a sensor (yaw, pitch, roll, x, y, and z). On the other hand, as the latter approach, corresponding features between successive images are firstly extracted and a transformation matrix is then estimated to minimize the deviation of the successive images. Both approaches are normally integrated to achieve better performance.

Conventional methods fall into two categories according to their applications. One is bundle adjustment, which is well developed in photogrammetry to minimize image projection errors with global optimization conducted jointly to all images and their ground truth. Bundle adjustment can achieve high accuracy but requires considerable number of ground control points (GCPs), which impose intensive labor for their acquisition. However, bundle adjustment is the primary method in remote sensing industry for producing accurate maps and survey products. On the other hand, the method of using camera parameters and image features is considered to reduce the requirements for GCPs. In addition, a proper trade-off between automation and accuracy is generally taken into consideration in non-measurement oriented applications of those methods, such as visualization, simulation, and surveillance.

However, it is in fact almost impossible to completely align images because any image is inherently inaccurate and has displacement, distortion, motion parallax and moving objects. All of this contributes to mosaicing errors and causes curling effect on a mosaic strip that is a set of a plurality of successive images because errors are passed on from one image to the next image and accumulate. Therefore the mosaic strip, which should extend in a linear manner, possibly goes any direction. To mitigate the mosaicing curling, it is necessary to adjust the image transformation parameters (i.e., transformation matrix) by using additional control information.

The deviation between the curled mosaic strip and its ground truth indicates the amount of necessary adjustment. The existing methods directly adopt linear minimization of error and interpolate the accumulated error into each image in sequence. This method results in an adjustment transformation along the shortest path between the curled and real mosaic strips, such as the bundle adjustment and a method described in JP 2006-189940 A. This method works well only without rotation or with small rotation. But if the mosaic strip curls significantly with a big turning angle, the existing methods fail to average accumulated error and intermediate images appear to be flipped, and buildings appear to be collapsed onto a line or even a point in a certain case.

In order to mitigate the image mosaicing curling effect, the accumulated error must be fairly interpolated into the sequential image segments while the adjustment on the image transformation should not result in a drastic change on the shape of each image segment. The direct interpolation of the accumulated error as in the conventional methods causes the intermediate images to be flipped, and collapsed onto a line or even a point in a certain case if the mosaic strip curls significantly with a big turning angle.

### SUMMARY OF THE INVENTION

This invention has been made in view of the above, and it is therefore an object of this invention to effectively mitigate the curling of a mosaic strip image by spreading errors accumulated in image projection and image mosaicing over the entire length of the mosaic strip.

A representative aspect of this invention is as follows. That is, there is provided an image mosaicing system for generating a mosaic image by compositing a plurality of sequential images which partially overlap with one another, including: a storage unit which stores the plurality of sequential images; an input unit which obtains control information on the plurality of sequential images stored in the storage unit; a display unit which displays computation results as a mosaic image; a processing unit which performs computation; a memory which stores information for the computation; and an output unit which outputs the generated mosaic image. The processing unit includes: a matrix calculating module which calculates a transformation matrix for transformation between two adjacent images obtained from among the plurality of sequential images; an adjustment element generating module which generates an adjustment element of the estimated transformation matrix; and an image projecting module which projects each image on a mosaic plane by using the transformation matrix to which the calculated adjustment element has been applied. The matrix calculating module obtains two adjacent images from among the plurality of sequential images; extracts corresponding features from the two adjacent images; and estimates a transformation matrix for transformation between the two adjacent images in order to minimize a total deviation between the corresponding features. The adjustment element generating module generates an adjustment element of the estimated transformation matrix; obtains first control information, which is for projecting a first image included in a mosaic strip onto a predetermined mosaic plane, and second control information, which is for projecting a last image included in the mosaic strip onto the mosaic plane; estimates a first transformation matrix, which transforms the first image onto the mosaic plane, and a last transformation matrix, which transforms the last image onto the mosaic plane by referring to the obtained control information; estimates a second transformation matrix, which transforms the last image to an image on the mosaic plane by referring to the first transformation matrix estimated by the adjustment element generating module and the transformation matrix estimated by the matrix calculating module for transformation between images; decomposes a difference between the estimated last transformation matrix and the estimated second transformation matrix into rotational components and perspective components; and calculates adjustment elements of the decomposed rotational components and adjustment elements of the decomposed perspective components. The image projecting module estimates a transformation matrix for transforming each image included in the mosaic strip to an image on the mosaic plane by using the first transformation matrix estimated by the adjustment element generating module and the transformation matrix estimated by the matrix calculating module for transformation between images, and by applying the calculated adjustment elements; and projects the image onto the mosaic plane by referring to the transformation matrix estimated for each image.

According to an aspect of this invention, the image mosaicing curling effect can be mitigated.

### BRIEF DESCRIPTION OF THE DRAWINGS

The present invention can be appreciated by the description which follows in conjunction with the following figures, wherein:

FIG. 1 is a block diagram showing a structure of an image compositing system according to an embodiment of this invention;

FIGS. 2A and 2B are flow charts of image mosaicing processing according to the embodiment of this invention;

FIG. 3 is an explanatory diagram showing information that is input and output according to the embodiment of this invention;

FIG. 4 is an explanatory diagram showing image transformation according to the embodiment of this invention;

FIG. 5 is an explanatory diagram showing image transformation according to the embodiment of this invention;

FIG. 6 is a flow chart showing details of computation processing of rotation and perspective transformation according to the embodiment of this invention;

FIG. 7 is a flow chart showing details of an adjusted transformation matrix computation processing according to the embodiment of this invention;

FIG. 8 is an explanatory diagram showing how images are mosaiced by a transformation matrix according to the embodiment of this invention;

FIG. 9 is an explanatory diagram showing a comparison between transformation that uses an interpolated matrix according to the embodiment of this invention and conventional image transformation; and

FIG. 10 is an explanatory diagram showing a comparison between the embodiment of this invention which uses an interpolated matrix and prior art in transformation of an image with a large rotation angle.

### DETAILED DESCRIPTION OF THE PREFERRED EMBODIMENTS

An outline of an embodiment of this invention will be given first.

The embodiment of this invention describes an image mosaicing method of generating a mosaic image from sequential images that are photographed by a camera and partially overlap with one another. Instead of treating the accumulated error in the same way as in prior art, the embodiment of this invention firstly decomposes the accumulated error into rotational and perspective components, and then applies feasible linear interpolation on each component respectively. Therefore each image segment can be adjusted relatively smoothly without flipping even if the mosaic strip curls with a big turning angle. As a result, the accumulated error is mitigated and spread evenly over the mosaic strip. The embodiment of this invention can thus achieve much better visually pleasing and correctly geo-referenced mosaic.

Now a description on the embodiment of this invention will be given with reference to the accompanying drawings.

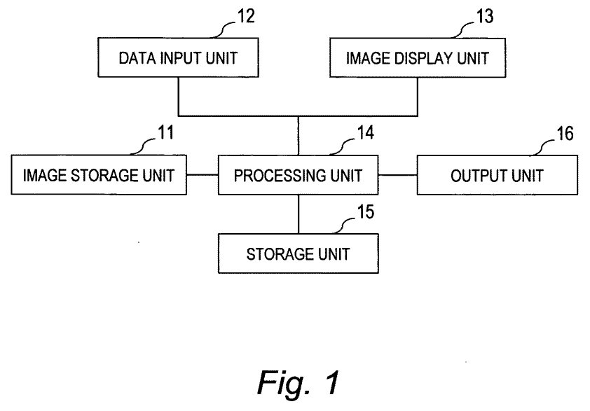

FIG. 1 is a block diagram showing the structure of an image compositing system according to the embodiment of this invention.

The image compositing system of this embodiment has an image storage unit 11, a data input unit 12, an image displaying unit 13, a processing unit 14, a storage unit 15, and an output unit 16.

The image storage unit 11 is a storage that stores images (mosaic strip) to be processed by this image compositing system. The data input unit 12 is a user interface through which an operator enters an instruction, and is composed of a keyboard and a pointing device. The image displaying unit 13 is a display device on which an image processed by this image compositing system is displayed.

The processing unit 14 is a processor that has a CPU or the like to execute processing provided by this image compositing system. The storage unit 15 is a storage that stores a program run by the processing unit 14 and data used in running the program. The output unit 16 is an interface that outputs an image processed by this image compositing system to another device.

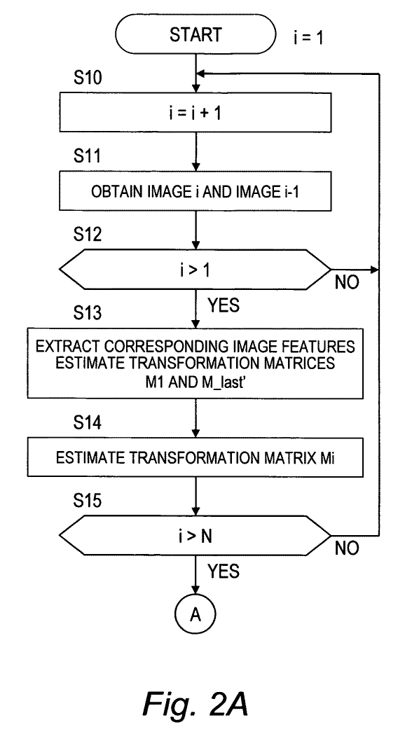

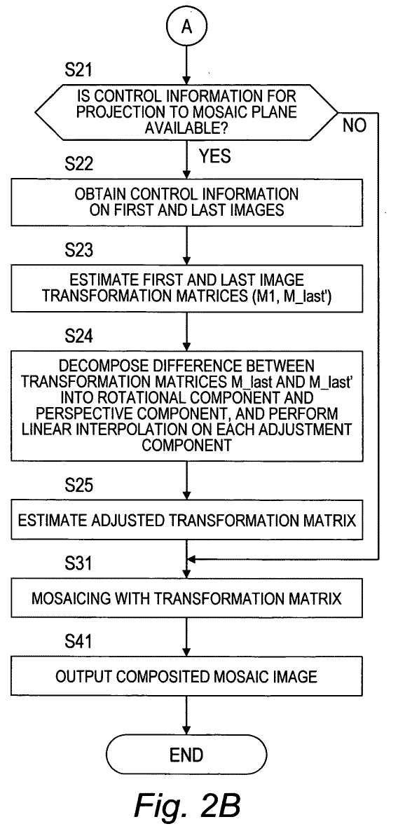

FIG. 2A and FIG. 2B are flow charts of processing of generating a mosaic image by compositing images according to the embodiment of this invention.

First, aerial photographs (images) or the like taken in succession are input in order. The input images are numbered, starting from i=1. The initial value of i is set to “1” and 1 is added to the image control parameter i (S10). Thereafter, two (an image i and an image i−1) of the input images are retrieved (S11).

It is judged whether or not it is possible to retrieve two images (an image 2 and an image 1) by determining whether the image control parameter i is larger than 1 or not (S12). When the parameter i is equal to or smaller than 1, the processing returns to Step S10 in order to retrieve the next image in line. When the parameter i is larger than 1, the processing proceeds to Step S13.

Features of the images are extracted next (S13). Common image processing methods such as Canny edge detection and Harris corner detection may be employed for the image feature extraction.

Next, the corresponding relationship between the extracted features is inferred by template matching. A transformation matrix (homography) Mi for transforming the image i to the image i−1 is then obtained with the use of the least square method (S14). In Step S14, the image i−1 is the master image and the image i is the slave image.

A pyramidal implementation of Lucas-Kanade, which tracks optical flow features, is quite popular and effective to combine feature extraction and matching together. Further, random sample consensus (RANSAC) is normally applied to reject outliers of correspondences.

Whether or not the image control parameter i is larger than N is judged next (S15). N represents the total count of the sequential images (a maximum number the image control parameter). When the parameter i is equal to or smaller than N, it means that there are images yet to be processed, and the processing returns to Step S10 in order to retrieve the next image in line. When the parameter i is larger than N, it means that the transformation matrix Mi has been obtained for every image, and the processing proceeds to Step S21. The processing is repeated in this manner until the last image to obtain a sequence of transformation matrices.

The transformation matrices are adjusted by supplying control information in order to mitigate the mosaicing curling effect. The conventional methods such as bundle adjustment require considerable numbers of GCPs. This invention judges whether or not the control information on the first and the last images is available (S21).

When it is judged as a result that the control information on the first and last images is available, the control information is fetched and written in the storage unit 15 (S22). When at least one piece of the control information on the first image and the control information on the last image is unavailable, the processing moves to Step S31.

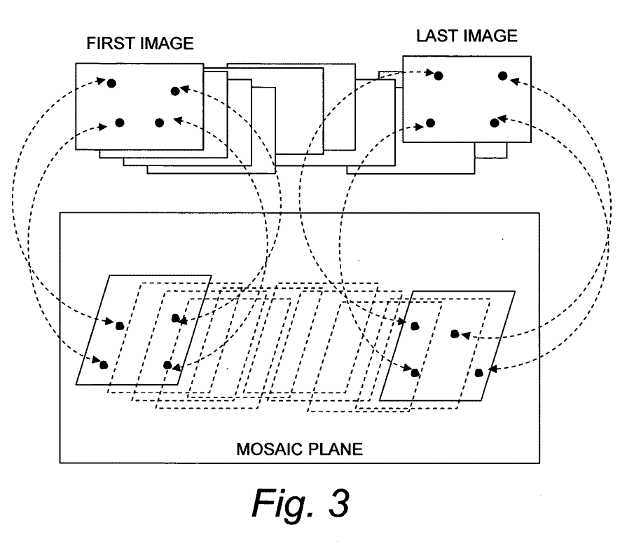

As shown in FIG. 3, the term control information here refers to information that associates a feature in an image with a point on the mosaic plane (reference plane). An operator enters control information by assigning a point on the mosaic plane (for example, a point on a map) to a point in an image with a pointing device such as a mouse. Because perspective transformation requires at least four points to estimate a transformation matrix, four corresponding points for each of the first and the last images are necessary.

After the control information is obtained, two transformation matrices (M1, M_last′) which transform the first image and the last image onto the mosaic plane, respectively, are estimated in Step S23. With transformation matrices of images at the two ends of a mosaic strip, the mosaic strip can be fixed in its right place. In Step S23, an image on the mosaic plane is the master image and an image on the mosaic strip is the slave image.

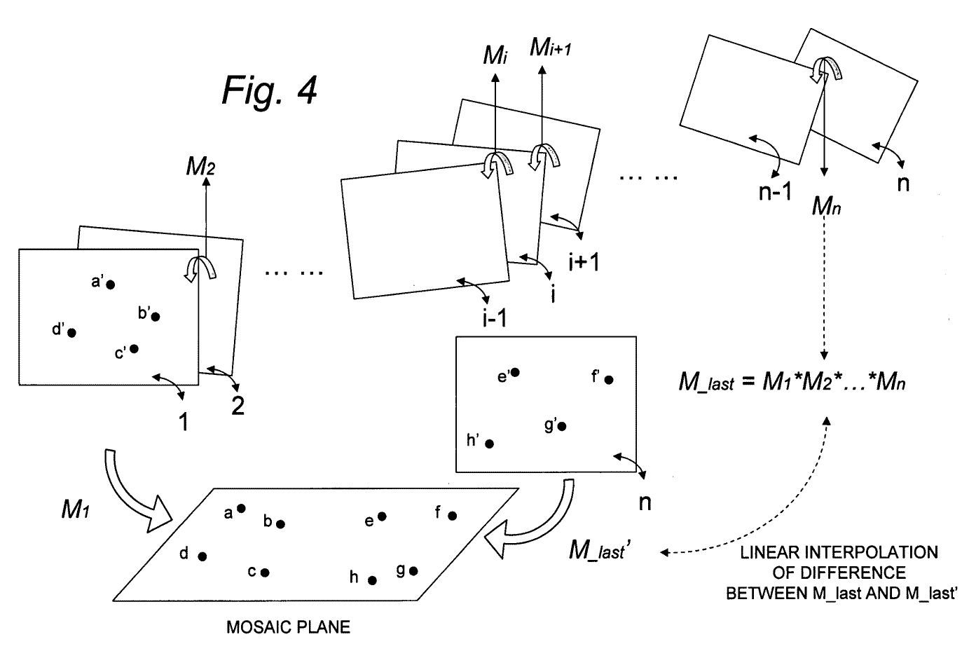

Mosaicing errors occur while registering images and are transited from the first image to the last image of mosaic strip. Accordingly, every mosaicing error is accumulated and transited from the first image to the last image of the mosaic strip. As illustrated in FIG. 4, the last image is transformed onto the mosaic strip through the matrix M_last (M_last=M1*M2* . . . Mi* . . . Mn). Here, Mi (i=2 to n) is a transformation matrix which transforms the image i to the subsequent image i−1.

Meanwhile, the ground truth or the should-be position of the last image can be determined using the transformation matrix M_last′ which is estimated from the obtained control information. The deviation between the matrix M_last′ and the matrix M_last indicates the total amount of the accumulated errors. If the accumulated errors can be fairly interpolated into the sequential image segments, the curled mosaic strip will appear along the correct course. In order to mitigate mosaic curling effect, it is necessary to implement a smooth evolution between the matrices M_last′ and M_last.

The embodiment of this invention accomplishes this by decomposing a transformation matrix into rotational and simple perspective components, thereby enabling feasible linear matrix interpolation (S24).

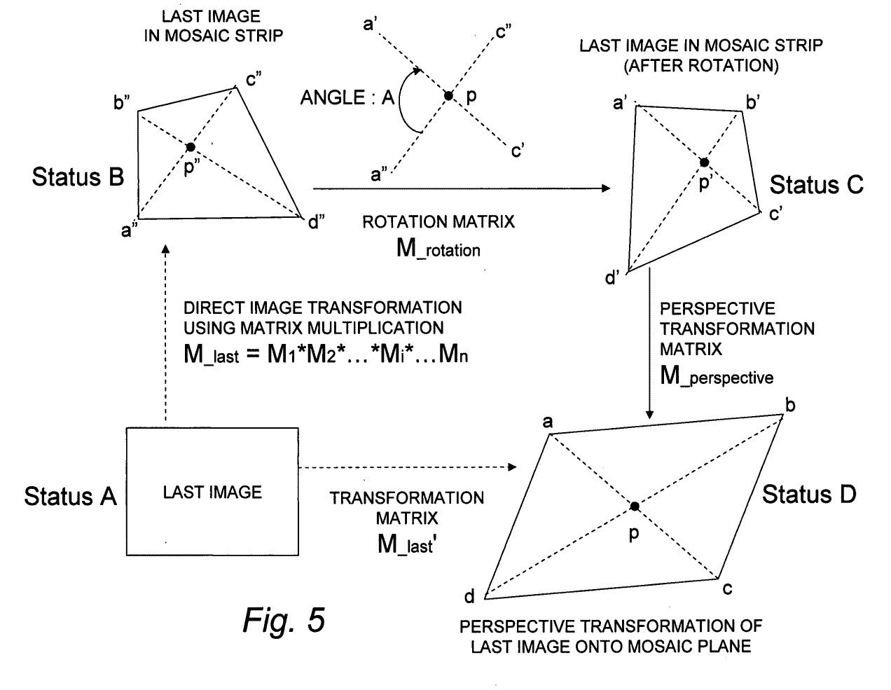

Because perspective transformation preserves a straight line, the intersection point of the two diagonals of an image frame always corresponds to the principle point (PP) of perspective projection. The PP is invariant to rotation and perspective transformation. This invention derives a quantitative form to describe the spatial direction of an image as illustrated in FIG. 5. The orientation of an image is referred to as the angle between the primary diagonal and x-axis in this specification, but it could be defined as the angle between any diagonal and any axis.

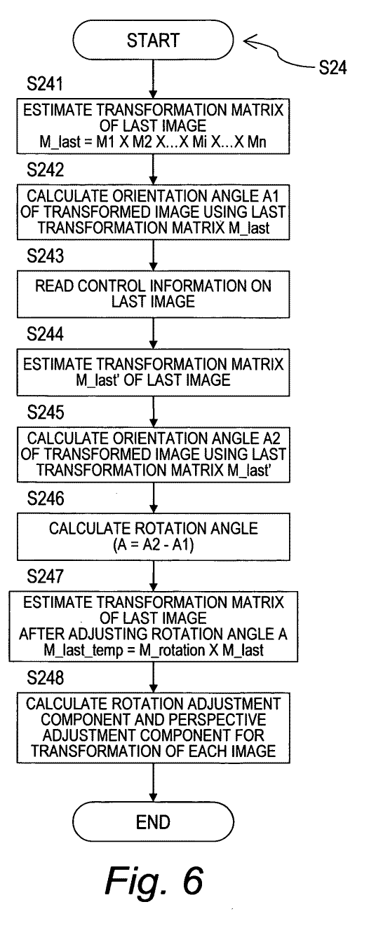

FIG. 6 is a flow chart showing details of the computation processing (S24) of rotation and perspective transformation according to the embodiment of this invention.

First, the matrix M_last (M_last=M1*M2* . . . Mi* . . . Mn) is estimated (S241), where the matrix M_last is the transformation matrix which transforms the last image to an image on the mosaic plane and the matrix Mi is the transformation matrix which transforms the image i to the subsequent image i−1. An orientation angle A1 of the last image with respect to the mosaic strip is then calculated (S242).

Next, the control information on the last image is read out of the storage unit 15 in order to estimate the transformation matrix M_last′ of the last image (S243). The transformation matrix M_last′ is estimated based on the read control information (S244). The last image is transformed with the transformation matrix M_last′, and an orientation angle A2 is obtained, which is the orientation angle on the mosaic strip (ground truth) of the resultant image transformed with the transformation matrix M_last′ (S245).

An angle difference A between the two orientation angles is calculated (S246). The angle difference (A=A2−A1) indicates the rotational component of the accumulated mosaic errors, and is a rotation angle used in an adjustment that brings an image projected onto the mosaic plane and containing accumulated errors to its ground truth (mosaic plane) position.

Next, the matrix M_last is decomposed into the product of two matrices M_rotation and M_last_temp, that is, the final transformation matrix of last image is decompose into M_rotation and M_last_temp (S247). Here, M_rotation is a rotation matrix of the rotation angle A, and M_last_temp is a simple perspective transformation matrix containing very small rotational components, and is within a stable and safe range for matrix linear interpolation. In this manner, the method of this embodiment makes it possible to confine the linear interpolation of transformation on the mosaic plane and avoid convergence of an image to a point in the interpolation of transformation with a large rotational component.

A rotation adjustment component M_rotation_i and a perspective adjustment component M_perspective_i are next calculated for each image (S248). The rotation adjustment component M_rotation_i is a rotation matrix of an orientation angle Ai, and is defined as Ai=A/(N−1)*(i−1), where N is the count of images in the mosaic strip. The perspective adjustment component M_perspective_i is calculated by the following Expression 1 using Alexa's matrix:

[(1−t)ΘA]⊕(tΘB) (1)

tε[0,1]

where the matrix A represents a rotation matrix which rotates the calculated rotation angle A, the matrix B represents the matrix M_last′, and the operators are expressed by the following Expressions 2 and 3:

sΘA=e^{s log A} (2)

A⊕B=e^{log A+log B} (3)

It is to be noted that the derivation of the perspective adjustment component is described in detail in Shmuel Peleg, Alex Rav-Acha and Assaf Zomet, “Mosaicing on Adaptive Manifolds”, IEEE Transactions on Pattern Analysis and Machine Intelligence, Col. 22, No. 10, October 2000.

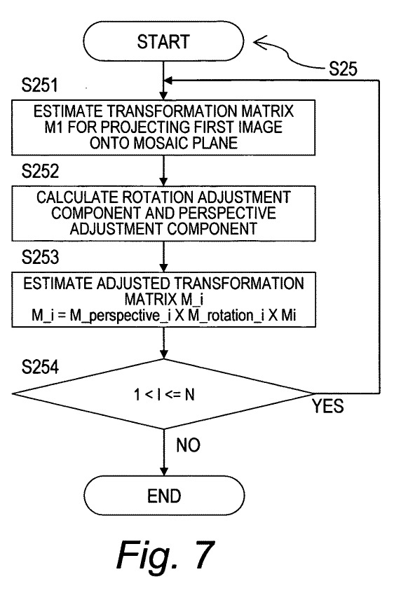

Back to FIG. 2B, each image is adjusted with the adjusted transformation matrix after the transformation adjustment amounts in terms of rotational and perspective components are derived through the processing shown in FIG. 6 (S25). Details of the image adjusting processing is shown in FIG. 7.

First, the transformation matrix M1 estimated from the obtained control information is defined as M_1 (S251). The matrix M1 (M_1) is the transformation matrix which transforms the first image to an image on the mosaic plane.

Next, the rotation adjustment component M_rotation_i and the perspective adjustment component M_perspective_i are calculated for the image i (S252). The calculated adjustment components are applied to the transformation matrix Mi to obtain an adjusted transformation matrix M_i (S253). Specifically, M_i is expressed as M_i=M_perspective_i* M_rotation_i* Mi, where Mi is the transformation matrix which transforms the image i to the image i−1. M_i is the transformation matrix which transforms the image i to a curling effect-mitigated image on the mosaic plane.

Next, it is judged whether or not the image control parameter i is larger than 1 and equal to or less than N (S254). When the image control parameter i is larger than 1 and equal to or less than N, it means that there are images for which transformation matrices are yet to be estimated, and the processing returns to Step S252 to repeat the cycle. On the other hand, when the image control parameter i is outside of the given range, it means that the transformation matrix has been estimated for every image. The processing therefore ends this part and moves on to Step S31.

By applying the adjusted transformation matrix M_i, every image is transformed to a certain amount in rotation and perspective for compensating the accumulated errors, so that the curling effect is reasonably mitigated to achieve a much better visually pleasing and correctly geo-referenced mosaic.

FIG. 4 and FIG. 5 show image transformation according to the embodiment of this invention.

Due to the uncertainty of processing, mosaicing errors occur while registering images and are transited from the first image to the last image of the mosaic strip. Accordingly, the total mosaicing errors are accumulated and transited to the last image of the mosaic strip. As illustrated in FIG. 4, the last image is transformed to the mosaic strip through the matrix M_last=M1*M2* . . . Mi* . . . Mn, where Mi is the homography which transforms the image i to the image i−1. Meanwhile, the ground truth or the should-be position of the last image can be determined using the homography M_last′, which can be estimated from the available control information e.g. given four GCPs. The present invention reduces the requirements for GCPs to a minimum level which only uses the given control information in the first and last images, that is, four control points for each of the first and last images, so that a total of eight GCPs are required in minimum against hundreds of GCPs in conventional ways. With these given eight control points, the two ends of the mosaic strip can be fixed at their “should-be” positions, and then we can calculate the offset between the last image of a curled mosaic strip and its should-be position. The deviation between the matrices M_last′ and M_last indicates the total amount of accumulated errors. The curled mosaic strip will appear along the correct course when the accumulated errors are fairly interpolated into the sequential image segments. Therefore, the question of how to mitigate the mosaic curling effect becomes how to implement smooth evolution between the matrices M_last′ and M_last. The present invention decomposes a transformation matrix into rotational and simple perspective components to enable the feasible linear matrix interpolation at step S24.

Now, the process changing images by the above processing will be described with reference to FIG. 4.

The projection matrix (transformation matrix) M1 for projection onto the mosaic plane is estimated from the control information on the first image (the image 1). Similarly, the projection matrix M_last′ for projection onto the mosaic plane is estimated from the control information on the last image (an image n). For transformation between successive images, the transformation matrices M2 to Mn are estimated with the use of corresponding features of the images. Mi is a transformation matrix for transformation from the image i to the image i−1 as shown in FIG. 4.

The projection matrix M_i for projecting each image onto the mosaic plane can be obtained from these transformation matrices by following the mosaic strip down from the image 1 (M_i=M1*M2* . . . *Mi). In a similar manner, the projection matrix M_last for projecting the image n onto the mosaic plane is obtained by following the mosaic strip down from the image 1(M_last=M1*M2* . . . *Mn).

The difference between the two projection matrices M_last′ and M_last obtained for the image n is estimated, and is linear-interpolated to adjust the projection matrix M_i for projection of each image onto the mosaic plane. The difference between the projection matrices M_last′ and M_last is first decomposed into a rotational component and a perspective component.

Linear interpolation is performed on the resultant rotational component M_rotation and perspective component M_perspective separately as shown in FIG. 5.

The linear adjustment amount of the rotational component is calculated by dividing, into equal parts, the angle difference A between the orientation angle A1 of the image n projected onto the mosaic plane with the projection matrix M_last, and the orientation angle A2 of the image n projected onto the mosaic plane with the projection matrix M_last′. The equally divided parts match the intervals of the sequential images.

The obtained projection matrices M1, M_i (i=2 to n−1), and M_last′ are used to project the respective images (the image 1 to the image n) onto the mosaic plane. An orientation angle from a given axis is then obtained for each image projected onto the mosaic plane. The calculated rotational component adjustment amount is added to the orientation angle of each image, to thereby adjust the rotational component of each image projected onto the mosaic plane.

Thereafter, the perspective component adjustment amount of each image is calculated by the above Expression 1.

The usual linear interpolation model is given by the following Expression 4:

[(1+t)×A]+(t×B) 0≦t≦1 (4)

Direct interpolation of two statuses A and B results in a transformation evolving from one end to another of the mosaic strip along the shortest path and it will flip intermediate images if a large rotation is present for a 3D perspective transformation. Moreover, the above Expression 4 can not be directly applied to the matrices. Alexa's matrix provides a method for generating arbitrary linear combinations of matrices. Two operators Θ represented in Expression 2 and ⊕ represented in Expression 3 developed in Alexa method are implemented using the matrix logarithm and exponential. The operator Θ implements scalar multiplication of a transformation matrix, and the operator ⊕ is similar to matrix multiplication, with the exception that ⊕ is commutative.

For linear interpolation of the matrices, we can rewrite Expression 4 as Expression 5 based on Expressions 2 and 3, and we have our curled strip correction model:

[(1−t)ΘM_{—last}]⊕(tΘM_{—last}′) (5)

We can generate adjustment matrices by directly applying Expression 5 in some cases, but unfortunately Alexa method might be unstable in some cases. The matrix square root fails to converge for many transformations with rotational component >=90 degree combined with a non-uniform scale. Therefore, we first decompose the transformation matrix into a rotational component and a perspective transformation component, and then apply Expression 4 to the rotational component and apply Alexa method only to the above perspective transformation component to ensure it always works within a stable and safe range.

As illustrated in FIG. 5, the last image (Status A) is transformed to an image (Status B) in the mosaic strip via the matrix M_last, meanwhile its ground truth (Status D) is determined via the homography M_last′ derived from the given ground control points. The “difference” between Status B and Status D in both position and shape indicates the accumulated error. As discussed above, we need to make a transformation scheme to evolve Status B to Status D smoothly so as to alleviate the accumulated error fairly into the image segments. We first rotate Status B by an angle to get Status C, which has generally similar orientation as Status D, then apply Alexa method to linearly interpolate Status C to Status D. In this manner, the rotational component will be always very small from Status C to Status D, and it ensures Alexa method works safely.

Since we suppose the optical axis of the camera is perpendicular to the flat scene, and the principle point (PP) of perspective projection corresponds to the centre of the image frame, the intersection of two diagonals is approximately at the principle point. And because perspective projection preserves straight lines, in an image after a perspective projection, the intersection of two diagonals of an image frame always corresponds to the principle point. In FIG. 5, we notate the diagonal a-c, a′-c′, and a″-c″ as primary diagonals, and b-d, b′-d′ and b″-d″ as secondary diagonals. The orientation of image is herein referred to as the angle between the primary diagonal and the x-axis, but it could be an angle between any diagonal and any axis and a necessary conversion is required for consistency. Once the orientation of image is determined, the rotation angle can be simply calculated via the difference of their orientations. The present invention derives a quantitative form to describe the spatial direction of the image as illustrated in FIG. 6.

Described next are the effects of the embodiment of this invention.

The embodiment of this invention can effectively mitigate the curling of a mosaic image composited from projected images (a mosaic strip) by using control information on the first image and the last image alone.

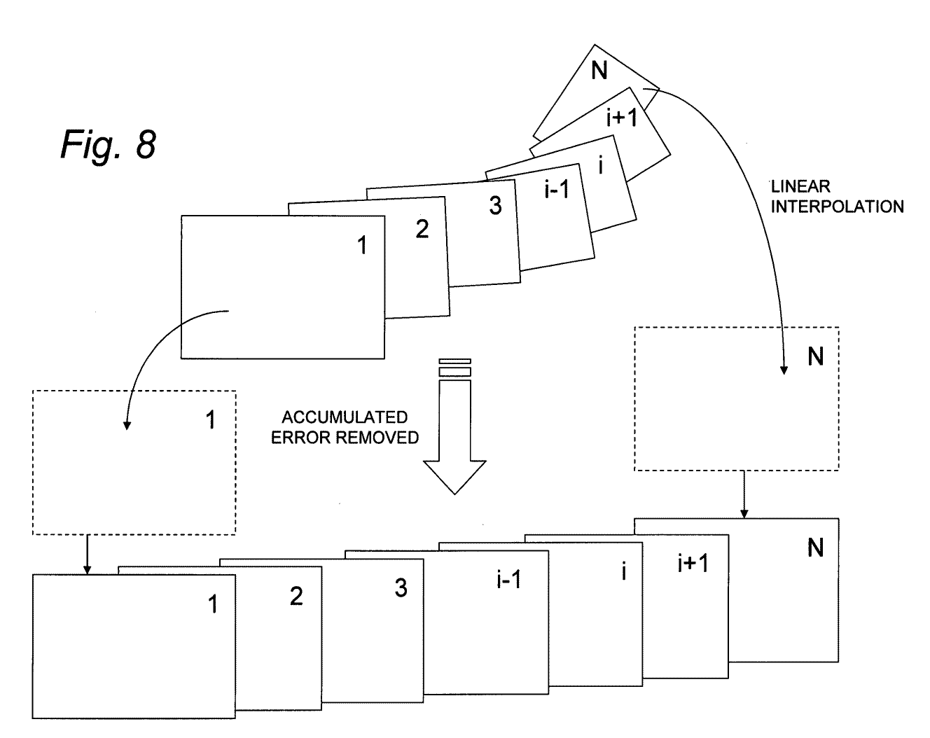

FIG. 8 is an explanatory diagram of image mosaicing with a transformation matrix according to the embodiment of this invention. The concept of this invention is described with reference to FIG. 8.

The first and last images in a set of sequential images are at the two ends of a mosaic strip. The embodiment of this invention uses control information on the first image and control information on the last image in order to mitigate the curling of the mosaic strip which is caused by accumulated errors. With the control information on the last image, accumulated errors in image mosaicing can be derived from the offset of the last image on the curled mosaic strip against its ground truth or should-be position. According to the transformation matrix interpolation method of this invention, the accumulated errors can be evenly spread over the mosaic strip, and the curling effect of the mosaic strip can be effectively mitigated.

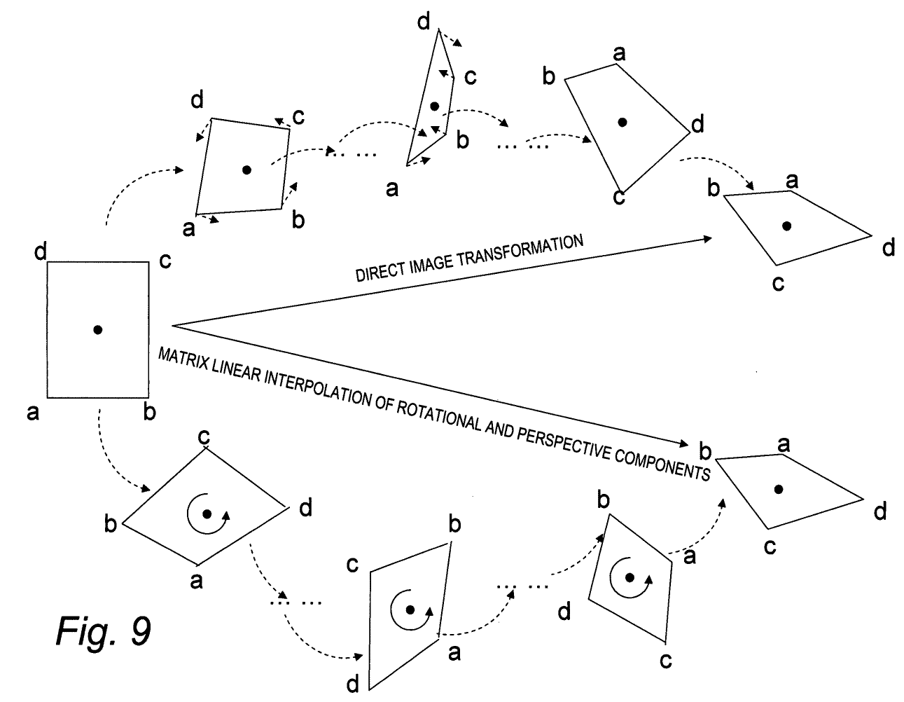

FIG. 9 shows a comparison between transformation that uses an interpolated matrix according to the embodiment of this invention and conventional image transformation.

The method of this invention decomposes the transformation into a rotational component and a perspective component. The conventional direct interpolation methods such as the bundle adjustment can not handle a curled mosaic strip with large rotation and fail to average accumulated errors. As a result, intermediate images appear to be flipped, and buildings appear to be collapsed onto a line or even a point.

The method of this invention actually confines the linear interpolation of transformation onto a mosaic plane and evenly spreads the accumulated errors by decomposing the transformation into a rotational component and a perspective component.

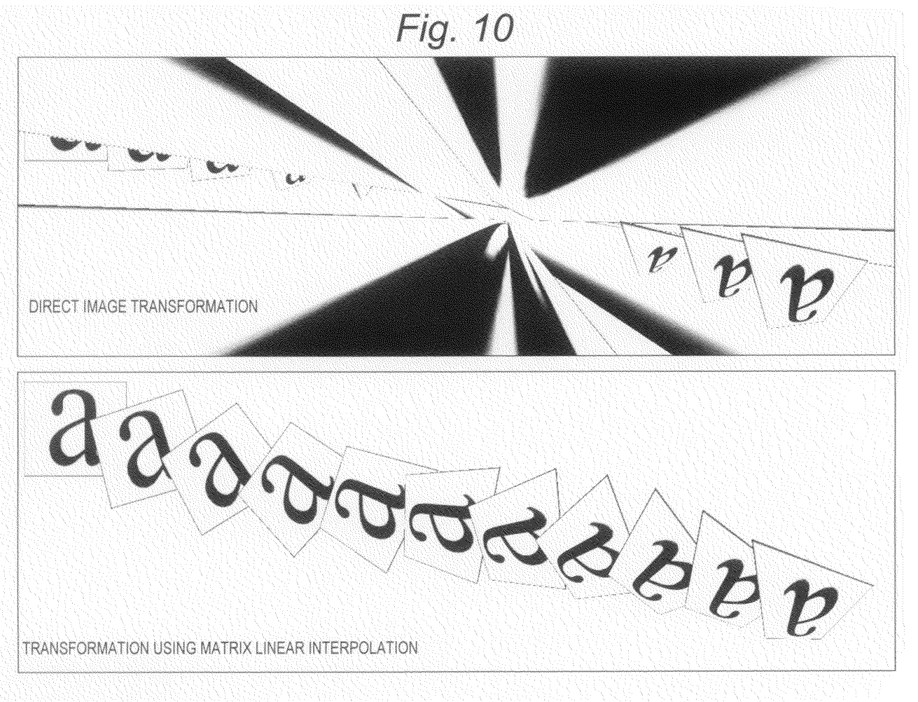

FIG. 10 is a comparison between the embodiment of this invention which uses an interpolated matrix and prior art in transformation of an image with a large rotation angle.

FIG. 10 shows that, whereas the conventional image transformation method causes intermediate images to flip when the rotation angle is large, the method of this invention is free from the flipping of intermediate images.

Recently, it has become very easy to acquire massive imagery, and image processing such as mosaicing has found applications in such fields as survey, engineering, and entertainment with the use of various common user-grade digital cameras or handy video cameras. This invention, which employs a different approach from prior art, is quick mosaicing for generating a large overview from single images or frames. This invention enables feasible linear interpolation for transformation by decomposing image transformation into a rotational component and a simple perspective component.

According to this invention, errors accumulated during mosaicing and make a mosaic image curl are spread evenly over the entire length of the mosaic strip. This invention thus effectively mitigates the mosaicing curling effect and achieves much better visually pleasing and correctly geo-referenced mosaic.

This invention is very promising for mosaicing images taken from unmanned aerial vehicles (UAVs), micro aerial vehicles (MAVs), and other similar imaging systems, which provide very coarse sensing parameters only. Also this invention is good for normal digital cameras, hand held video cameras, and other similar image sensors, which don't provide sufficient sensor attitude information.

While the present invention has been described in detail and pictorially in the accompanying drawings, the present invention is not limited to such detail but covers various obvious modifications and equivalent arrangements, which fall within the purview of the appended claims.

What is claimed is:

1. An image mosaicing system for generating a mosaic image by compositing a plurality of sequential images which partially overlap with one another, comprising:
a storage unit which stores the plurality of sequential images;
an input unit which obtains control information on the plurality of sequential images stored in the storage unit;
a display unit which displays computation results as a mosaic image;
a processing unit which performs computation;
a memory which stores information for the computation; and
an output unit which outputs the generated mosaic image,
wherein the processing unit includes:
a matrix calculating module which calculates a transformation matrix for transformation between two adjacent images obtained from among the plurality of sequential images;
an adjustment element generating module which generates an adjustment element of the estimated transformation matrix; and
an image projecting module which projects each image on a mosaic plane by using the transformation matrix to which the calculated adjustment element has been applied,
wherein the matrix calculating module is configured to:
obtain two adjacent images from among the plurality of sequential images;
extract corresponding features from the two adjacent images; and
estimate a transformation matrix for transformation between the two adjacent images in order to minimize a total deviation between the corresponding features,
wherein the adjustment element generating module is configured to:
generate an adjustment element of the estimated transformation matrix;
obtain first control information, which is for projecting a first image included in a mosaic strip onto a predetermined mosaic plane, and second control information, which is for projecting a last image included in the mosaic strip onto the mosaic plane;
estimate a first transformation matrix, which transforms the first image onto the mosaic plane, and a last transformation matrix, which transforms the last image onto the mosaic plane by referring to the obtained control information;
estimate a second transformation matrix, which transforms the last image to an image on the mosaic plane by referring to the first transformation matrix estimated by the adjustment element generating module and the transformation matrix estimated by the matrix calculating module for transformation between images;
decompose a difference between the estimated last transformation matrix and the estimated second transformation matrix into rotational components and perspective components; and
calculate adjustment elements of the decomposed rotational components and adjustment elements of the decomposed perspective components, and
wherein the image projecting module is configured to:
estimate a transformation matrix for transforming each image included in the mosaic strip to an image on the mosaic plane by using the first transformation matrix estimated by the adjustment element generating module and the transformation matrix estimated by the matrix calculating module for transformation between images, and by applying the calculated adjustment elements; and
project the image onto the mosaic plane by referring to the transformation matrix estimated for each image.

2. The image mosaicing system according to claim 1,
wherein the first control information is information for projecting the first image to geo-register, and
wherein the second control information is information for projecting the last image to geo-register, and is used to spread errors accumulated in projecting images onto the mosaic plane over the entire images included in the mosaic strip.

3. The image mosaicing system according to claim 1, wherein the adjustment element generating module is designed to:
calculate an orientation angle A1 of the last image transformed by the last transformation matrix;
calculate an orientation angle A2 of the last image transformed by the second transformation matrix;
calculate a difference between the calculated orientation angles to obtain a rotation angle A=A2−A1;
calculate an increment of the rotation angle A′=A/(N−1) by dividing the obtained rotation angle A by N−1, N being number of images included in the mosaic strip; and
calculate an increment of a perspective matrix by referring to the obtained rotation angle increment as the adjustment elements of the rotational components.

4. The image mosaicing system according to claim 3, wherein the adjustment element generating module is configured to:
retrieve coordinates of four vertices of the image;
determine an intersection point of two diagonals of the image as an origin;
determine an arbitrary axis that runs through the origin; and
calculate an angle between one of the two diagonals and the determined axis with respect to the determined origin to obtain the orientation angle of the image.

5. The image mosaicing system according to claim 1, wherein the adjustment element generating module calculates the perspective components using the following Expression 1:
[(1−t)ΘA]⊕(tΘB) (1)
tε[0,1]
where the matrix A represents a rotation matrix which rotates the calculated rotation angle A, the matrix B represents the second transformation matrix, and the operators are expressed by the following Expressions 2 and 3:
sΘA=e^{s log A} (2)
A⊕B=e^{log A+log B} (3)

6. An image mosaicing method of generating a mosaic image by compositing a plurality of sequential images which partially overlap with one another with the use of a computer, comprising:
a first step of calculating a transformation matrix for transformation between two adjacent images obtained from among the plurality of sequential images;
a second step of generating an adjustment element of the estimated transformation matrix; and
a third step of projecting each image on a mosaic plane by using the transformation matrix to which the calculated adjustment element has been applied,
wherein the first step includes the steps of:
obtaining two adjacent images from among the plurality of sequential images;
extracting corresponding features from the two adjacent images; and
estimating a transformation matrix for transformation between the two adjacent images in order to minimize a total deviation between the corresponding features,
wherein the second step includes the steps of:
generating an adjustment element of the estimated transformation matrix;
obtaining first control information, which is for projecting a first image included in a mosaic strip onto a predetermined mosaic plane, and second control information, which is for projecting a last image included in the mosaic strip onto the mosaic plane;
estimating a first transformation matrix, which transforms the first image onto the mosaic plane, and a last transformation matrix, which transforms the last image onto the mosaic plane by referring to the obtained control information to;
estimating a second transformation matrix, which transforms the last image to an image on the mosaic plane by referring to the first transformation matrix estimated in the second step and the transformation matrix estimated in the first step for transformation between images to;
decomposing a difference between the estimated last transformation matrix and the estimated second transformation matrix into rotational components and perspective components; and
calculating adjustment elements of the decomposed rotational components and adjustment elements of the decomposed perspective components, and
wherein the third step includes the steps of:
estimating a transformation matrix for transforming each image included in the mosaic strip to an image on the mosaic plane by using the first transformation matrix estimated in the second step and the transformation matrix estimated in the first step for transformation between images, and by further applying the calculated adjustment elements; and
project the image onto the mosaic plane by referring to the transformation matrix estimated for each image.

7. The image mosaicing method according to claim 6,
wherein the first control information is information for projecting the first image to geo-register, and
wherein the second control information is information for projecting the last image to geo-register, and is used to spread errors accumulated in projecting images onto the mosaic plane over the entire images included in the mosaic strip.

8. The image mosaicing method according to claim 6, wherein the step of calculating adjustment elements separately for the rotational components and the perspective components includes:
calculating an orientation angle A1 of the last image transformed by the last transformation matrix;
calculating an orientation angle A2 of the last image transformed by the second transformation matrix;
calculating a difference between the calculated orientation angles to obtain a rotation angle A=A2−A1;
calculating an increment of the rotation angle A′=A/(N−1) by dividing the obtained rotation angle A by N−1, N being number of images included in the mosaic strip; and
calculate an increment of a perspective matrix by referring to the obtained rotation angle increment as the adjustment elements of the rotational components.

9. The image mosaicing method according to claim 8, wherein the step of calculating the orientation angle of the last image includes:
retrieving coordinates of four vertices of a transformed image;
determining an intersection point of two diagonals of the image as an origin;
determining an arbitrary axis that runs through the origin;
calculating an angle between one of the two diagonals and the determined axis; and
calculating the orientation angle between one of the two diagonals and the determined axis with respect to the determined origin to obtain the orientation angle of the image.

10. The image mosaicing method according to claim 6, wherein the step of calculating adjustment elements separately for the rotational components and the perspective components comprises calculating the perspective components by the following Expression 1:
[(1−t)ΘA]⊕(tΘB) (1)
tε[0,1]
where the matrix A represents a rotation matrix which rotates the calculated rotation angle A, the matrix B represents the second transformation matrix, and the operators are expressed by the following Expressions 2 and 3:
sΘA=e^{s log A} (2)
A⊕B=e^{log A+log B} (3).
